(19) United States
(12) Patent Application Publication
(10) Pub. No.: US 2001/0019230 A1
(43) Pub. Date: Sep. 6, 2001

(54) MOTOR HAVING ROTATIONAL-SPEED DETECTOR

(76) Inventor: SHIGERU FURUKI, FUKUSHIMA-KEN (JP)

Correspondence Address: BRINKS HOFER GILSON & LIONE, P.O. BOX 10395, CHICAGO, IL, 60610, US

(21) Appl. No.: 09/119,509

(22) Filed: Jul. 20, 1998

(30) Foreign Application Priority Data
Jul. 24, 1997 (JP) 9-198461

(51) Int. Cl. H02K 11/00

(52) U.S. Cl. 310/68 B

(57) ABSTRACT

A motor provided with a rotational-speed detector has a driving coil for driving the motor, a driving magnetized portion, a rotational-speed detecting magnetized portion, and a frequency generator (FG) pattern. When the number of magnetic poles of the driving magnetized portion is indicated by n, and the number of magnetic poles of the rotational-speed detecting magnetized portion is represented by m, m and n are selected to satisfy a condition expressed by m/a:n/a=an even number:an even number, where a indicates a given integer, and the number of detecting lines of the FG pattern is set to be m/a. Upon rotating the motor, magnetic flux produced from the driving magnetized portion passes through the detecting lines to generate power in the detecting lines. However, since a total number of detecting lines facing the N poles of the driving magnetized portion is equal to that facing the S poles, the current induced in the detecting lines due to the magnetic flux from the driving magnetized portion is canceled. As a consequence, the level of a rotational-speed detection output of the motor is stabilized, thereby achieving highly precise rotational-speed control.

### BACKGROUND OF THE INVENTION

1. Field of the Invention

The present invention generally relates to driving motors for use in, for example, floppy disk drives, and more particularly, to a motor provided with a detector for detecting the rotational speed of a rotor.

2. Description of the Related Art

Referring to FIG. 8, a known brushless motor 30 is configured in the following manner. A coil substrate 32 and ring stator coils 33 are provided on a stator base 31. A detecting substrate 34 formed by printing a number-of-rotation detecting frequency generator (FG) pattern 35 on a flexible substrate is further mounted on the stator coils 33. Rotatably supported on the detecting substrate 34 is a rotor magnet 36 whose peripheral portion serves as a main magnetized portion 37 for driving the motor 30 and central portion serves as a FG magnetized portion 38 for detecting the number of rotations. In the main magnetized portion 37, N poles and S poles are alternately magnetized in the circumferential direction. In the stator coil 33, a current radially flows in a linear portion 33a, and due to a combination of such a current and the magnetic poles of the main magnetized portion 37, an electromagnetic force acts on the rotor magnet 36 to rotate it.

In the FG magnetized portion 38 of the rotor magnet 36, N poles and S poles are alternately formed in the circumferential direction at a pitch narrower than the pitch used for the main magnetized portion 37. In the FG pattern 35, detecting portions 35a are formed at a narrow pitch within which a current radially flows. The FG pattern 35 is positioned to face the FG magnetized portion 38. Upon rotating the rotor magnet 36, the FG pattern 35 outputs a frequency generating (FG) signal according to the magnetic poles of the FG magnetized portion 38, thereby detecting the number of rotations of the rotor magnet 36. In response to the FG signal from the FG pattern 35, a current supplied to the stator coils 33 is controlled. This makes it possible to rotate the rotor magnet 36 at a constant speed.

As discussed above, in the above-described motor 30, a rotational force acts on the rotor magnet 36 by a combination of a current flowing in the stator coils 33 and the magnetic poles of the main magnetized portion 37, which is formed on the peripheral portion of the rotor magnet 36.

As shown in FIG. 8, however, the main magnetized portion 37 and the FG magnetized portion 38 are provided in the proximity with each other and are integrally formed with the rotor magnet 36. Accordingly, magnetic flux generated from the main magnetized portion 37 passes through the FG pattern 35, thereby disadvantageously encouraging superimposition of the magnetic flux on the FG signal as noise.

Namely, an abnormal current induced in the detecting portion 35a due to the positional relationship between the main magnetized portion 37 and the FG pattern 35 adds to a normal current radially flowing in the detecting portion 35a of the FG pattern 35 generated by the FG pattern 35 according to the magnetic poles of the FG magnetized portion 38. This may change the waveform level of a detected frequency according to the rotational frequency of the rotor magnet 36. More specifically, the FG pattern 35 is formed, as illustrated in FIG. 8, over the entire 360° of the circumference direction. Then, a current is induced in a certain detecting portion 35a due to magnetic flux generated from the main magnetized portion 37, and there must be another detecting portion 35a that generates a current reverse to the above-mentioned current. It is thus possible to offset both currents with each other, thereby eliminating noise. However, if the FG pattern 35 cannot be formed in the overall circumferential direction, but formed only to about 300°, because of limitation in the space to achieve the miniaturization of a motor, a current, which is not easily offset, may be induced in the FG pattern 35. In this case, the level of the FG signal obtained from the FG pattern 35 is disadvantageously changed according to the rotational frequency of the rotor magnet 36. This produces errors in detecting the number of rotations, thereby failing to control the rotation of the motor 30 properly.

In order to protect the FG pattern 35 from an adverse influence of the main magnetized portion 37, the main magnetized portion 37 and the FG magnetized portion 38 may be separately formed as different components. This, however, makes the structure of the motor 30 complicated, hampers the miniaturization of the motor 30, and also increases the cost.

### SUMMARY OF THE INVENTION

Accordingly, in order to solve the aforementioned problems, it is an object of the present invention to provide a motor having a rotational-speed detector in which a magnetized portion for driving the motor and a magnetized portion for detecting the number of rotations of the motor are provided in proximity with each other, and any detected pattern influenced by the magnetic flux generated from the rotor-driving magnetized portion can be canceled.

In order to achieve the above object, according to the present invention, there is provided a motor provided with rotational-speed detection means. The motor includes a stator. A rotor is rotatably provided on the stator. A driving coil is provided adjacent to the stator. A driving magnetized portion is provided adjacent to the rotor and has N poles and S poles that are alternately magnetized in the circumferential direction at a regular pitch. A rotational-speed detecting magnetized portion is provided adjacent to the rotor and has N poles and S poles that are alternately magnetized in the circumferential direction at a regular pitch. A detecting pattern is provided adjacent to the stator in such a manner that it faces the rotational-speed detecting magnetized portion. The detecting pattern, which is formed in a zigzag shape, has radially extending detecting lines in accordance with a pitch between each of the N poles and each of the S poles of the rotational-speed detecting magnetized portion. In this motor, a number of detecting lines of the detecting pattern and a number of poles of the driving magnetized portion are determined so that a total number of detecting lines facing the N poles of the driving magnetized portion is constantly equal to a total number of detecting lines facing the S poles of the driving magnetized portion.

In the aforementioned motor, when a number of magnetic poles of the driving magnetized portion is indicated by n, and a number of magnetic poles of the rotational-speed detecting magnetized portion is represented by m, m and n may preferably be selected to satisfy a condition expressed by m/a:n/a=an even number:an even number, where a indicates a given integer, and a detecting pattern having m/a number of detecting lines may be determined as one block, and at least one block may be provided for the motor.

In addition to the magnetic flux generated from the rotational-speed detecting magnetized portion, the magnetic flux is generated from the driving magnetized portion and adversely influences the radially extending detecting lines for detecting the rotational speed, thereby exciting a current in the detecting lines.

According to the present invention, therefore, a detecting pattern having one block or having a plurality of blocks which are connected in series with each other is configured so that a total number of detecting lines facing the N poles of the driving magnetized portion is constantly equal to a total number of detecting lines facing the S poles. Accordingly, the current induced in the detecting lines due to the N poles of the driving magnetized portion is reliably offset by the current generated in the detecting lines due to the S poles, regardless of the rotation phase of the rotor. It is thus possible to prevent an output of noise from the detection pattern caused by the magnetic flux from the driving magnetized portion.

To achieve the foregoing, the relationship between the number of detecting lines and the number of poles of the driving magnetized portion should be reliably constant within one block. More specifically, the magnetic poles of the rotational-speed detecting magnetized portion are placed at the same pitch as the detecting lines. Thus, if the relationship between the number of poles of the driving magnetized portion and that of the rotational-speed detecting magnetized portion is set to be constant, the total number of detecting lines facing the N poles of the driving magnetized portion is equal to that facing the S poles within one block of the detecting pattern. This relationship remains unchanged while the rotor is being rotated. As a consequence, the current generated in the detecting lines due to the magnetic poles of the driving magnetized portion is reliably canceled.

To establish the above-described relationship, as discussed above, the ratio of the number of poles m of the rotational-speed detecting magnetized portion to the number of poles n of the driving magnetized portion is set to be m/a:n/a=an even number:an even number, and the number of detecting lines within one block is set to be m/a.

### BRIEF DESCRIPTION OF THE DRAWINGS

FIG. 1 is a sectional view illustrating a motor according to an embodiment of the present invention;

FIG. 2 is a plan view illustrating a coil unit for use in the motor shown in FIG. 1;

FIG. 3 is a plan view illustrating a FG pattern, partially not shown, for use in the motor shown in FIG. 1;

FIG. 4 is a perspective view illustrating a rotor magnet for use in the motor shown in FIG. 1;

FIG. 5 is a sectional view, partially enlarged, illustrating the path of magnetic flux generated from a rotor magnet;

FIG. 6 illustrates the state in which the magnetic flux generated from a rotor magnet is canceled;

FIG. 7, which is comprised of FIGS. 7A and 7B, is a plan view illustrating modifications made to the FG pattern for use in the motor of the present invention; and

FIG. 8 is an exploded perspective view illustrating the main configuration of a known motor.

### DESCRIPTION OF THE PREFERRED EMBODIMENT

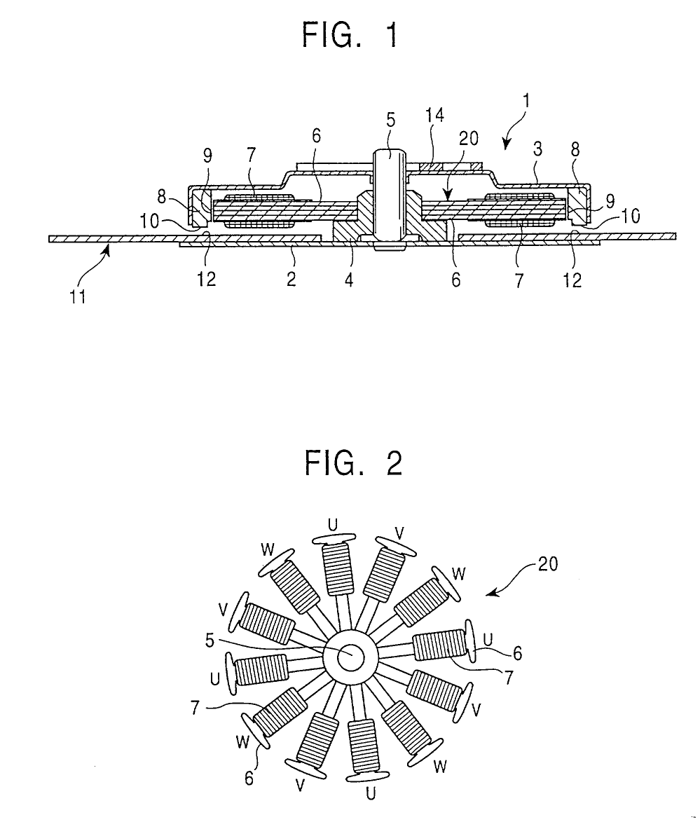

A motor having a rotational-speed detector according to an embodiment of the present invention is now described in detail with reference to FIGS. 1 through 7.

Referring to the sectional view of FIG. 1, a motor generally indicated by 1 is configured in the following manner. A bearing 4 is fixed on a flat stator substrate 2, and a rotation shaft 5 fixed at the center of a circular rotor 3, which is formed in the shape of an inverted tray, is rotatably supported by the bearing 4. A coil unit 20 is secured on the stator substrate 2 in such a manner that it faces the rotor 3. A turntable 14 for placing a disk, which serves as an information recording medium, is mounted on the surface of the rotor 3 opposite to the surface facing the stator substrate 2.

The coil unit 20 is formed, as illustrated in the plan view of FIG. 2, of twelve radially extending iron-core yokes 6 and driving coils 7 wound around the center lines of the respective yokes 6. The coil unit 20 shown in FIG. 2 is for use in, for example, a three-phase motor, and is formed by sequentially and alternately arranging U-, V-, and W-phase yokes 6 with the corresponding coils 7. Driving currents having a phase difference of 120° are supplied to the respective U-, V-, and W-phase driving coils 7.

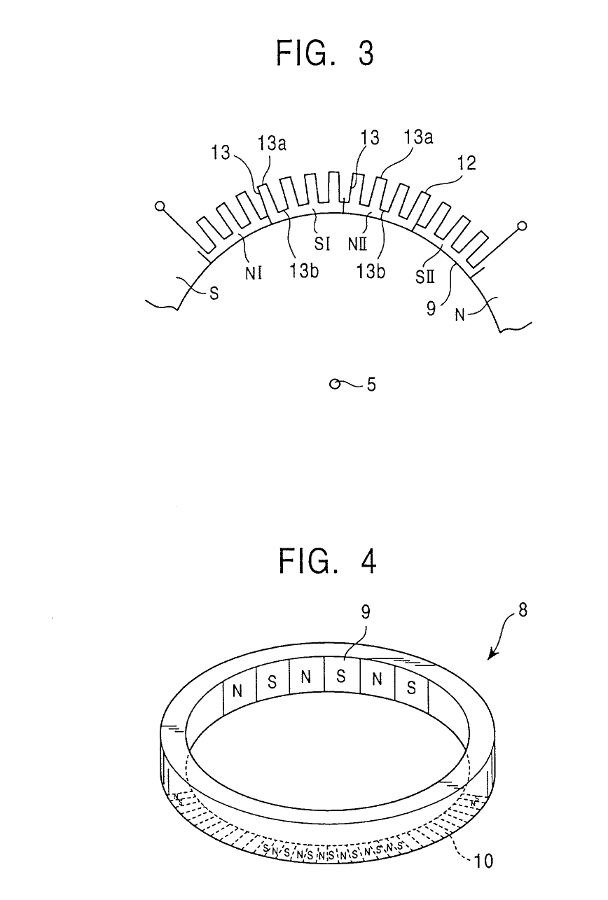

A flexible substrate 11 has a pattern which is formed by etching copper foil on the surface of the stator substrate 2 that faces the rotor 3. This pattern serves as a frequency generator (FG) pattern 12 used for detecting the number of rotations, and is arranged along a rotor magnet 8 (described later) formed on the peripheral portion of the rotor 3. FIG. 3 is a plan view illustrating one block of the FG pattern 12, which is formed by arranging radially extending detecting lines 13 at a regular pitch. Adjacent detecting lines 13 are connected to each other by outer peripheral lines 13a and inner peripheral lines 13b alternately. As a consequence, the FG pattern 12 is formed in a zigzag shape.

A rotor magnet 8 is fixed inside the peripheral portion of the rotor 3. Referring to the perspective view of the rotor magnet 8 in FIG. 4, a driving magnetized portion 9 is formed on the inner peripheral portion of the magnet 8 on the surface facing the forward end of the coil unit 20, and a rotational-speed detecting magnetized portion 10 is formed on the surface facing the FG pattern 12.

In the driving magnetized portion 9, N poles and S poles are alternately magnetized in the circumferential direction at a regular pitch. In the rotational-speed detecting magnetized portion 10, N poles and S poles are alternately magnetized in the circumferential direction at a regular pitch which is narrower than the pitch set in the driving magnetized portion 9. The pitch of the N poles and the S poles formed on the rotational-speed detecting magnetized portion 10 are equal to that of the radially extending detecting lines 13 of the FG pattern 12. Namely, the pitch between the boundaries of the N poles and the S poles of the rotational-speed detecting magnetized portion 10 is the same as the pitch of the detecting lines 13. Consequently, when the N pole of the rotational-speed detecting magnetized portion 10 faces any of the detecting lines 13, the S pole of the magnetized portion 10 inevitably faces the detecting line 13 adjacent to the line 13 facing the above N pole.

Further, in the one block of the FG pattern 12 illustrated in FIG. 3, the number of magnetic poles of the driving magnetized portion 9 and the number of detecting lines 13 are set so that the number of detecting lines 13 facing the N poles of the driving magnetized portion 9 is constantly equal to that facing the S poles. More specifically, when the number of magnetic poles of the driving magnetized portion 9 is indicated by n, and the number of magnetic poles of the rotational-speed detecting magnetized portion 10 is represented by m, m and n are selected to satisfy a condition of m/a:n/a=an even number:an even number, where a indicates a given integer. The example of the FG pattern 12 shown in FIG. 3 is formed such that the number of detecting lines is m/a. For example, a total number n of magnetic N and S poles of the driving magnetized portion 9 is 16, and a total number m of magnetic N and S poles of the rotational-speed detecting magnetized portion 10 is 120. If a given integer a is 4, m/a is 30 and n/a is 4, i.e., m/a:n/a=30:4 (an even number:an even number). In this case, if the number of detecting lines 13 within one block of the FG pattern 12 is set to be 30, as illustrated in FIG. 3, the total number of detecting lines 13 facing the N poles of the driving magnetized portion 9 is equal to that facing the S poles.

FIG. 3 illustrates the state in which the rotor magnet 8 is in a rotating position with respect to the rotational-speed detecting magnetized portion 10. At this position, the number of detecting lines 13 facing the magnetic poles of the driving magnetized portion 9 is as follows. The total number of detecting lines 13 facing the N poles is fourteen (seven with respect to each of N pole I and N pole II). The total number of detecting lines 13 facing the S poles is fourteen (seven with respect to each of S pole I and S pole II). The direction of the current induced in the detecting lines 13 due to the N poles of the driving magnetized portion 9 is reverse to the direction of the current generated in the detecting lines 13 due to the S poles. Thus, the overall current is offset in the FG pattern 12, thereby inhibiting the superimposition of noise generated from the driving magnetized portion 9 on the FG pattern 12.

FIG. 6 schematically illustrates a detailed state in which the current induced due to the magnetic poles of the driving magnetized portion 9 is canceled in the FG pattern 12. For simple representation, FIG. 6 illustrates the FG pattern 12 and the driving magnetized portion 9 when m/a n/a=6:2. In the present invention, a current generated due to the magnetic poles of the driving magnetized portion 9 can be reliably offset when the condition expressed by m/a:n/a=an even number:an even number is satisfied. In FIG. 6, when the angle of two poles of the driving magnetized portion 9 is 2π(rad), the angle of adjacent detecting lines 13 of the FG pattern 12 can be expressed by π/3(rad).

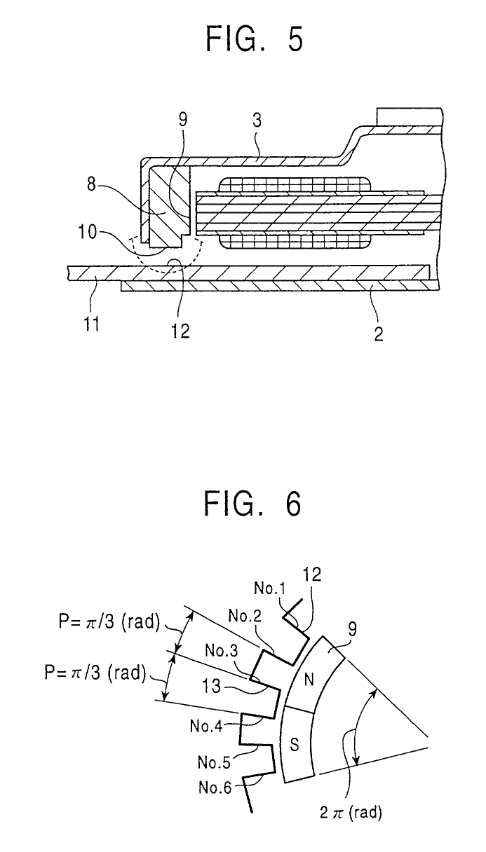

The dotted line shown in FIG. 5 represents a path of the magnetic flux generated from the driving magnetized portion 9. The magnetic flux passes through the detecting lines 13 perpendicularly, thereby generating power in the detecting lines 13. The rotor magnet 8 is rotated to generate power inward or outward in the radial direction in the detecting lines 13 (No. 1 through No. 3) adjacent to the N poles and also to generate power inward or outward in the radial direction in the detecting lines 13 (No. 4 through No. 6) adjacent to the S poles. Namely, when the power signal generated in detecting line No. 1 due to the magnetic flux from the driving magnetized portion 9 is indicated by V1(t)=sin(ωt), the power signal generated in detecting line No. 4 and having a phase difference π from the signal V1(t) can be expressed by V4(t)=sin(ωt+π). Thus, the relationship of V1(t)=−V4(t) holds true, and V1(t) and V4(t) are offset with each other. Similarly, the signal generated in detecting line No. 2 is balanced with that in detecting line No. 5. The signal produced in detecting line No. 3 is canceled by that in detecting line No. 6.

By virtue of the aforementioned relationship, power generating components only caused by the magnetic flux from the driving magnetized portion 9 are canceled without influencing power generating components caused by the magnetic flux from the rotational-speed detecting magnetized portion 10.

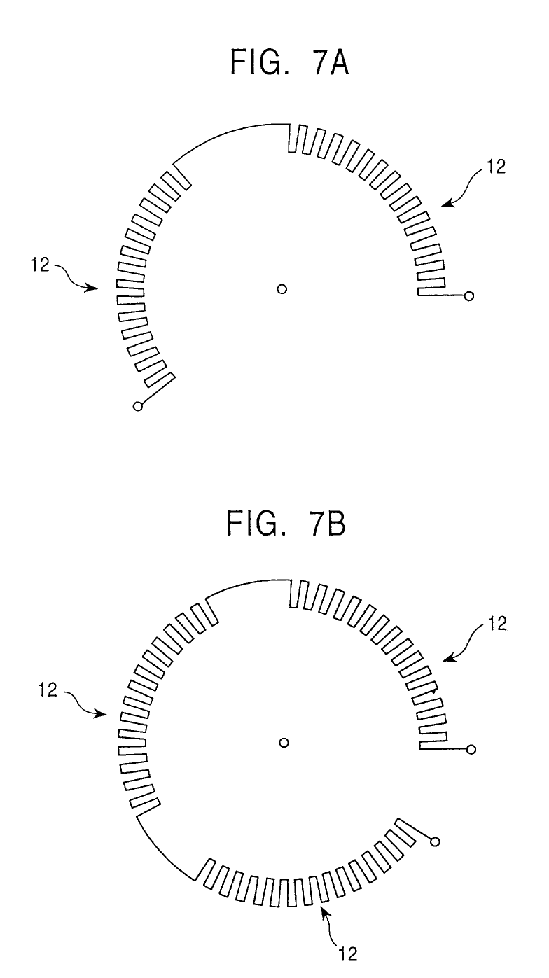

The above-described configuration is given as an example only, and any configuration that satisfies the following condition may apply to the present invention. When the number of magnetic poles of the driving magnetized portion 9 is indicated by n, and the number of magnetic poles of the rotational-speed detecting magnetized portion 10 is represented by m, m and n are selected to meet the condition of m/a:n/a=an even number:an even number, where a indicates a given integer. Also, detecting lines 13 having a number of m/a are set to be one block, and the FG pattern 12 is formed in units of blocks. FIG. 3 illustrates only one block of the FG pattern 12. However, a FG pattern 12 formed of two blocks, each having thirty detecting lines 13, which are connected in series with each other, as shown in FIG. 7A, may be used. Alternatively, a FG pattern 12 formed of three blocks, each having thirty detecting lines 30, which are connected in series with each other, as illustrated in FIG. 7B, may be employed.

According to the rotor magnet 8 provided for the motor 1 of the present invention, the detecting pattern (FG pattern) 12 is not adversely influenced by the magnetic flux generated from the driving magnetized portion 9, i.e., the FG pattern 12 is protected from noise. This can be achieved regardless of whether the driving magnetized portion 9 and the rotational-speed detecting magnetized portion 10 are formed of the same magnet and are placed in proximity with each other or whether the two components are formed of different magnets and placed adjacent to each other. Thus, the level of the high-frequency detection signal obtained from the FG pattern 12 can be stabilized, thereby making it possible to highly precisely control the rotational speed of the motor.

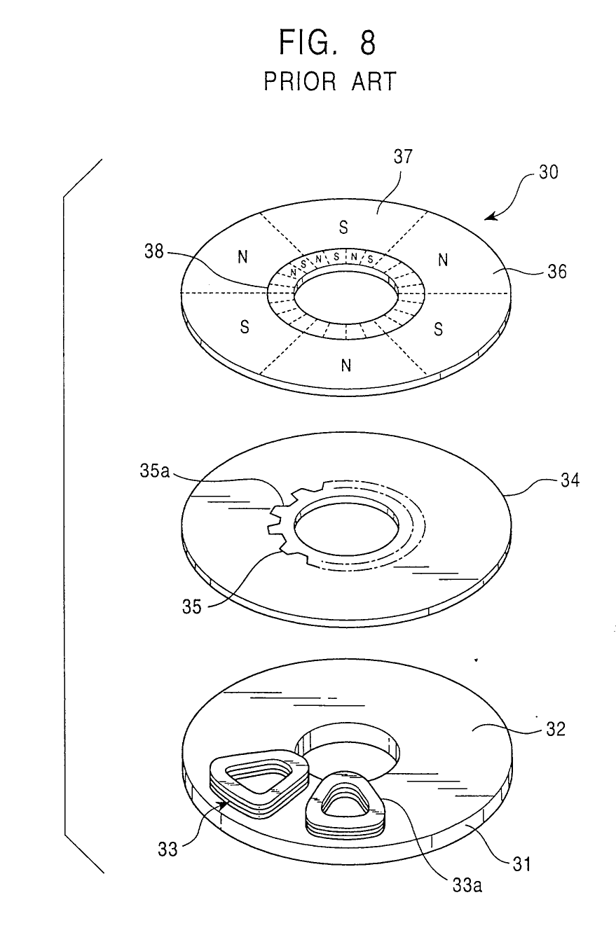

The coil unit used in the motor of the present invention is not restricted to the foregoing embodiment. For example, instead of using the coil unit 20 which is formed by winding the driving coils 7 around the iron-core yokes 6, such as the one shown in FIG. 2, stator coils, such as the one shown in FIG. 8, may be used.

As is seen from the foregoing description, the motor provided with a rotational-speed detector of the present invention offers the following advantages. The number of magnetic poles of the rotational-speed detecting magnetized portion and the number of magnetic poles of the driving magnetized portion are suitably set, thereby preventing the superimposition of noise generated from the driving magnetized portion on the rotational-speed detecting pattern.

What is claimed is:

1. A motor provided with rotational-speed detection means comprising:
a stator;
a rotor rotatably provided on said stator;
a driving coil provided adjacent to said stator;
a driving magnetized portion provided adjacent to said rotor and having N poles and S poles that are alternately magnetized in the circumferential direction at a regular pitch;
a rotational-speed detecting magnetized portion provided adjacent to said rotor and having N poles and S poles that are alternately magnetized in the circumferential direction at a regular pitch; and
a detecting pattern provided adjacent to said stator in such a manner that it faces said rotational-speed detecting magnetized portion, said detecting pattern, which is formed in a zigzag shape, having radially extending detecting lines, in accordance with a pitch between each of the N poles and each of the S poles of said rotational-speed detecting magnetized portion,
wherein a number of said detecting lines of said detecting pattern and a number of poles of said driving magnetized portion are determined so that a total number of said detecting lines facing the N poles of said driving magnetized portion is constantly equal to a total number of said detecting lines facing the S poles of said driving magnetized portion.

2. A motor according to claim 1, wherein in a case where a number of magnetic poles of said driving magnetized portion is indicated by n, and a number of magnetic poles of said rotational-speed detecting magnetized portion is represented by m, m and n are selected to satisfy a condition expressed by m/a:n/a=an even number:an even number, where a indicates a given integer, and a detecting pattern having m/a number of said detecting lines is determined as one block, and at least one block is provided for said motor.
